(19) United States
(12) Patent Application Publication
(10) Pub. No.: US 2005/0088624 A1
(43) Pub. Date: Apr. 28, 2005

(54) Projection display

(76) Inventors: Young-chol Lee, Suwon-si (KR); Il-kweon Moon, Suwon-si (KR)

Correspondence Address: STANZIONE & KIM, LLP, 1740 N STREET, N.W., FIRST FLOOR, WASHINGTON, DC, 20036, US

(21) Appl. No.: 10/854,701

(22) Filed: May 27, 2004

(30) Foreign Application Priority Data
Oct. 27, 2003 (KR) 2003-75226

(51) Int. Cl. G03B 21/00

(52) U.S. Cl. 353/31

(57) ABSTRACT

A projection display includes one or more reflective optical modulators and one or more illumination units which illuminate the one or more reflective optical modulators. Each of the one or more illumination units includes at least one collimator which includes a first reflective surface that is parabolic and reflects a light beam radiating from a lower portion toward a side portion, at least one compact light source which is located at a vicinity of a focus of the first reflective surface and sequentially radiates light beams toward the first reflective surface, at least one integrator which transforms light beams to have uniform intensities, and a polarization transformer which is located between the collimator and the integrator and transforms a light beam into one of first and second polarized beams.

### CROSS-REFERENCE TO RELATED APPLICATIONS

This application claims the priority of Korean Patent Application No. 2003-75226, filed on Oct. 27, 2003, in the Korean Intellectual Property Office, the disclosure of which is incorporated herein in its entirety by reference.

### BACKGROUND OF THE INVENTION

1. Field of the Invention

The present invention relates to a projection display, and more particularly, to a projection display using a compact light source, such as a light emitting diode, as a light source.

2. Description of the Related Art

FIG. 1 shows the structure of a conventional projection display. Referring to FIG. 1, the conventional projection display includes liquid crystal display (LCD) panels 20 (20R, 20G, and 20B) which are optical modulators, an illumination unit 10 which irradiates light onto the LCD panels 20R, 20G, and 20B, and a projection lens 40 which magnifies and projects a modulated image.

The LCD panels 20R, 20G, and 20B modulate red (R), green (G), and blue (B) beams, respectively, to be suitable for respective image data so as to display a color image. Reference numeral 30 denotes a synthesizing prism which combines the modulated R, G, and B beams and then irradiates the combined beam onto the projection lens 40.

The illumination unit 10 includes a light source 1, an integrator 3, a condenser lens 4, a plurality of mirrors 5R, 5G, and 5B, and a plurality of relay lenses 7 and 8.

The light source 1 may be a metal halide lamp or a super-high voltage mercury lamp and is located at a focal point of a reflective mirror 2 with a parabolic surface. The integrator 3 is used to irradiate a uniform beam onto the LCD panels 20R, 20G, and 20B and generally made of two fly-eye lenses in which micro-lenses are 2-dimensionally arrayed. A light beam, which has passed through the integrator 3, is condensed by the condenser lens 4. The mirrors 5R, 5G, and 5B are selective reflector mirrors which reflect the R, G, and B beams, respectively, and transmit other color beams. A light beam is split into the R, G, and B beams via the mirrors 5R, 5G, and 5B, respectively, and then the R, G, and B beams are incident on the LCD panels 20R, 20G, and 20B, respectively, through the relay lenses 7 and 8. The LCD panels 20R, 20G, and 20B modulate the R, G, and B beams, respectively, so as to output R, G, and B color images. The synthesizing prism 30 combines the R, G, and B beams output from the LCD panels 20R, 20G, and 20B into one, and then the projection lens 40 magnifies and projects the combined beam.

However, in such a conventional projection display, a lamp is used as a light source to illuminate optical modulators and has a short life span. Therefore, when the conventional projection display is used at home, the lamp should be frequently replaced with a new one. Also, the light source is large-sized. In order to solve these problems, studies on the use of compact light sources, such as a light emitting diode (LED) with a relatively long life span, etc., are in progress. Japanese Patent Publication No. JP 2001-42431 discloses a projection device using an LED.

To prevent such a loss of light, the conventional projection display includes secondary optics which condenses a light beam emitted from an LED before irradiating the light beam onto the optical modulators 20R, 20G, and 20B. As a result, the additional use of the secondary optics makes an illumination system of the conventional projection display complicated and increases manufacturing costs of the illumination system.

In general, an LED emits a smaller amount of light than a metal halide lamp or a super-high voltage mercury lamp. Thus, the conventional projection display uses an array of LEDs as a light source. In this case, secondary optics is necessary. However, since the secondary optics has to be lenses, light condensing efficiency deteriorates.

### SUMMARY OF THE INVENTION

In order sove the above and/or other problems, it is an aspect of the present general inventive concept to provide a projection display using a compact light source, such as an LED, so as to become compact and have a long life span.

In order sove the above and/or other problems, it is another aspect of the present general inventive concept to provide a simple structure projection display adopting a reflective optical modulator.

Additional aspects and advantages of the present general inventive concept will be set forth in part in the description which follows and, in part, will be obvious from the description, or may be learned by practice of the general inventive concept.

The above and/or other aspects of the present general inventive concept may be achieved by providing a projection display that may include an illumination unit which sequentially emits first, second, and third color beams, a reflective optical modulator which sequentially modulates the first, second, and third color beams so as to correspond to image data, a λ/4 plate which is installed in front of the reflective optical modulator, projection optics which magnifies and projects the modulated first, second, and third color beams, and a polarization beam splitter which allows the first, second, and third color beams to be incident on the reflective optical modulator and the modulated first, second, and third beams to be incident on the projection optics. The illumination unit can include a collimator, at least one compact light source, a polarization transformer, and at least one integrator. The collimator can include a first reflective surface that is parabolic and reflects a light beam radiating from a lower portion toward a side portion thereof, and a second reflective surface that includes an optical window through which the light beam radiates and that faces the first reflective surface. The at least one compact light source can be located at a vicinity of a focus of the first reflective surface and sequentially radiate the first, second, and third color beams toward the first reflective surface through the optical window. The polarization transformer can transform a light beam emitted from the collimator into one of a first polarized beam or a second polarized beam. The at least one integrator can transform a light beam emitted from the polarization transformer into light beams having uniform intensities.

The above and/or other aspects of the present general inventive concept may also be achieved by providing a projection display that may include a first illumination unit which comprises at least one first compact light source that emits a first color beam, a second illumination unit which comprises at least one second compact light source that emits second and third color beams, first and second reflective optical modulators which modulate the first color beam and the second and third color beams, respectively, so as to correspond to image data, λ/4 plates installed in front of the first and second reflective optical modulators, projection optics which magnifies and projects the modulated beams, a first polarization beam splitter which allows the first beam and the second and third color beams to be incident on the first and second reflective optical modulators, respectively, and the modulated beams to be incident on the projection optics, and a second polarization beam splitter which allows the first beam emitted from the first illumination unit and the second and third color beams emitted from the second illumination unit to be incident on the first polarization beam splitter. Each of the first and second illumination units can include at least one collimator, at least one integrator, and a polarization transformer. The at least one collimator can include a first reflective surface that is parabolic and reflects a light beam radiating from one of the first and second compact light sources located at a vicinity of a focus of the first reflective surface toward a side aperture thereof, and a second reflective surface that includes an optical window through which the light beam radiates and that faces the first reflective surface. The at least one integrator can transform light beams into beams to have uniform intensities. The polarization transformer can be installed between the collimator and the integrator and can transform a light beam into one of first and second polarized beams.

The above and/or other aspects of the present general inventive concept may also be achieved by providing a projection display that may include first, second, and third illumination units which radiate first, second, and third color beams, respectively, first, second, and third reflective optical modulators which modulate the first, second, and third color beams so as to correspond to image data, λ/4 plates installed in front of the first, second, and third reflective optical modulators, respectively, a color synthesizing member which transmits the first and second color beams and reflects the third color beam to synthesize the first, second, and third color beams, projection optics which magnifies and projects the synthesized beam, a first polarization beam splitter which allows the first and second color beams to be incident on the first and second reflective optical modulators, respectively, and the modulated beams to be incident on the color synthesizing member, a second polarization beam splitter which allows the first and second color beams to be incident on the first polarization beam splitter, and a third polarization beam splitter which allows the third color beam to be incident on the third reflective optical modulator and the modulated beams to be incident on the color synthesizing member. Each of the first, second, and third illumination units can include a collimator, at least one compact light source, at least one integrator, and a polarization transformer. The collimator includes a first reflective surface that is parabolic and reflects a light beam radiating from a lower portion toward a side portion thereof, and a second reflective surface that includes an optical window through which the light beam radiates and that faces the first reflective surface. The at least one compact light source can be located at a vicinity of a focus of the first reflective surface and can radiate a light beam toward the first reflective surface through the optical window. The at least one integrator can transform light beams to have uniform intensities. The polarization transformer can be installed between the collimator and the integrator and can transform a light beam into one of first and second polarized beams.

The above and/or other aspects of the present general inventive concept may be achieved by providing a projection display that may include first, second, and third illumination units which radiate first, second, and third color beams, respectively, first, second, and third reflective optical modulators which modulate the first, second, and third color beams so as to correspond to image data, λ/4 plates installed in front of the first, second, and third reflective optical modulators, respectively, a color synthesizing member which synthesizes the modulated first, second, and third color beams, first, second, and third polarization beam splitters which allow the first, second, and third color beams to be incident on the first, second, and third reflective optical modulators, respectively, and the modulated first, second, and third color beams to be incident on the color synthesizing member, and projection optics which magnifies and projects the synthesized beam. Each of the first, second, and third illumination units can include a collimator, at least one compact light source, at least one integrator, and a polarization transformer. The collimator can include a first reflective surface that is parabolic and reflects a light beam radiating from a lower portion toward a side portion thereof, and a second reflective surface that includes an optical window through which the light beam radiates and that faces the first reflective surface. The at least one compact light source can be located at a vicinity of a focus of the first reflective surface and can radiate a light beam toward the first reflective surface through the optical window. The at least one integrator transforms light beams to have uniform intensities. The polarization transformer can be installed between the collimator and the integrator and can transform a light beam into one of first and second polarized beams.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing a structure of a conventional projection display;

FIG. 2 is a view showing a projection display according to an embodiment of the present general inventive concept;

FIG. 3 is a perspective view showing an illumination unit of FIG. 2;

FIG. 4 is a perspective view showing an example of a compact light source of FIG. 3;

FIGS. 5 through 8 are cross-sectional views showing a collimator according to embodiments of the present general inventive concept;

FIG. 9 is a perspective view showing a collimator of FIGS. 7 and 8;

FIG. 10 is a graph showing the result of a simulation of relative intensity of light with respect to an emission angle at which a beam is emitted through an aperture of the collimator of FIG. 7;

FIG. 11 is a horizontal cross-sectional view showing a portion H of FIG. 3;

FIG. 12 is a vertical cross-sectional view showing another example of a polarization transformer;

FIG. 13 is a perspective view showing an integrator according to an embodiment of the present general inventive concept;

FIG. 14 is a perspective view showing an illumination unit according to another embodiment of the present general inventive concept;

FIG. 15 is a view showing a structure of a projection display including two reflective optical modulators, according to another embodiment of the present general inventive concept;

FIG. 16 is a perspective view showing a compact light source of FIG. 15;

FIG. 17 is a perspective view showing another second compact light source of FIG. 15;

FIG. 18 is a view showing a structure of a projection display including three reflective optical modulators, according to still another embodiment of the present general inventive concept; and

FIG. 19 is a view showing a structure of a projection display including three reflective optical modulators, according to yet another embodiment of the present general inventive concept.

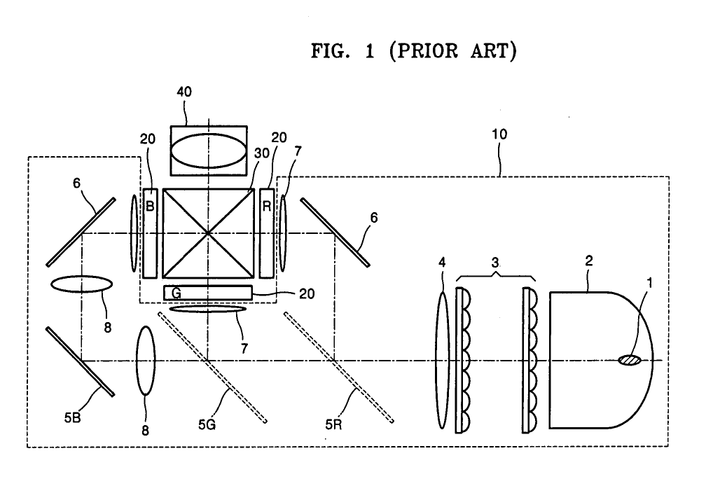

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present invention by referring to the figures.

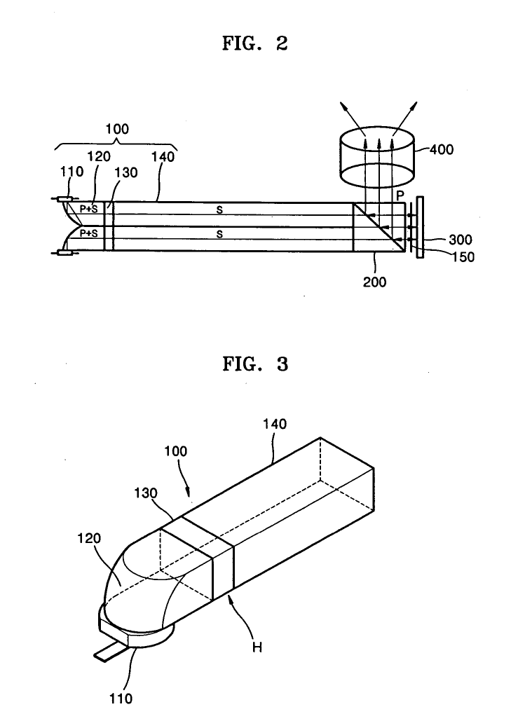

FIG. 2 is a view showing a structure of a projection display according to an embodiment of the present general inventive concept. Referring to FIG. 2, the projection display may include an illumination unit 100, a polarization beam splitter (PBS) 200, a reflective optical modulator 300, and projection optics 400. The reflective optical modulator 300 can selectively reflect light beams radiating from the illumination unit 100 to modulate the light beams corresponding to image data. The reflective optical modulator 300 may be, for example, a digital micromirror device (DMD), a digital light processor (DLP), a liquid crystal display (LCD) panel, a liquid crystal on silicon (LCOS) panel, or a direct drive light amplifier (DILA). The projection optics 400 can magnify and project the modulated beams. The illumination unit 100 can sequentially radiate first, second, and third beams, i.e., red (R), green (G), and blue (B) beams. The PBS 200 can transmit the first, second, and third beams toward the reflective optical modulator 300 and can reflect the modulated first, second, and third beams toward the projection optics 400.

FIG. 3 is a perspective view showing the illumination unit 300. Referring to FIG. 3, the illumination unit 300 may include a compact light source 110, a collimator 120, a polarization transformer 130, and an integrator 140.

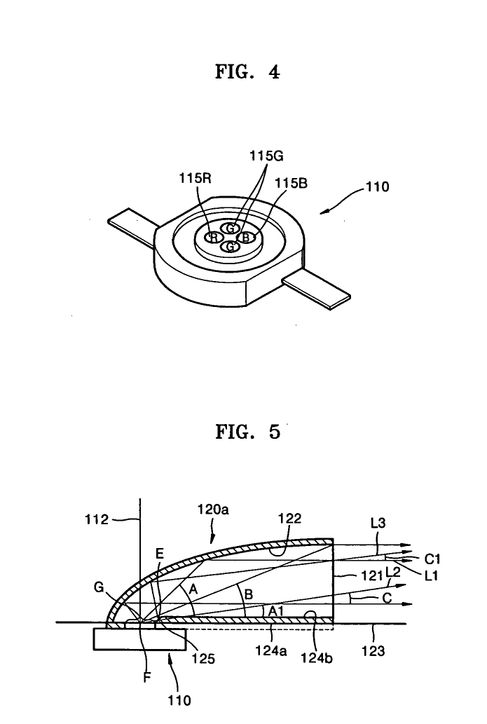

The compact light source 110 may be an LED, an organic electro luminescent (EL) device, or a laser diode. As shown in FIG. 4, LEDs 115R, 115G, and 115B, which radiate the R, G, and B beams, respectively, can be arrayed in the compact light source 110. Here, the number of each of LEDs 11 5R, 11 5G, and 11 5B can be appropriately determined depending on a color temperature and an illuminance of each of the R, G, and B beams.

FIG. 5 is a cross-sectional view showing an example of the collimator 120 (120a). Referring to FIGS. 3 and 5, the collimator 120a can be a hollow body having a side aperture 121, can collimate beams radiating from a lower portion thereof, and can emit the beam through the side aperture 121. A first reflective surface 122 can be provided on an inner surface of the collimator 120a to reflect beams. For example, the first reflective surface 122 can be a parabolic surface. The compact. light source 110 can be arrayed so that its emission point is positioned in the vicinity of a focus F of the first reflective surface 122. The LEDs 115R, 115G, and 115B can be arrayed so that a geometrical center connecting the LEDs 115R, 115G, and 115B is positioned in the vicinity of the focus F of the first reflective surface 122. As shown in FIG. 5, the compact light source 110 may be arrayed so that its optical axis 112 is almost perpendicular to a principal axis 123.

The collimator 120a may further include a second reflective surface 124a. The second reflective surface 124a can be positioned under the first reflective surface 122 and can include an optical window G through which light beams radiate. Although the second reflective surface 124a is a plane or a flat surface as illustrated in FIG. 5, this does not limit the scope of the present general inventive concept. In an aspect of the general inventive concept, the second reflective surface 124a may be a plane including the principal axis 123 and the focus F.

Also, the collimator 120a may further include a third reflective surface 125. The third reflective surface 125 can be inclined with respect to the principal axis 123 at an edge of the optical window G. In this case, as indicated by a reference numeral 124b, the second reflective surface 124a can be slightly stepped from the principal axis 123 toward the first reflective surface 122. In this embodiment, the second reflective surface 124b can be spaced apart from the principal axis 123 by a thickness corresponding to the third reflective surface in a direction perpendicular to the principal axis 123.

As described above, the first reflective surface 122 can be defined to have a parabolic shape. The parabolic shape may denote not only a strict parabolic shape whose conic coefficient K is 1, but also an a spherical shape whose conic coefficient K is in a range of −0.4 to −2.5, preferably, −0.7 to −1.6. The conic coefficient K of the first reflective surface 122 can be adequately determined as any value in the aforementioned range so that light emitted from the compact light source 110 is collimated to have a radiation angle range that enables the light to effectively illuminate the optical modulator 300. An example where the first reflective surface 122 has the strict parabolic shape whose K is 1 will now be described.

Light beams radiate from the compact light source 110 at a radiation angle A between 0° and 180° and are incident on the first reflective surface 122. In this embodiment, the radiation angle A is defined as an angle counterclockwise from the principal axis 123, and the first reflective surface 122 is a parabolic surface. Thus, a light beam L1 can radiate from the compact light source 110 at the radiation angle A greater than an aperture angle B, can be reflected from the first reflective surface 122 to be substantially parallel with the principal axis 123, and can be emitted through the side aperture 121. The light beam L1 is not incident on the third reflective surface 125. When the compact light source 110 does not include the third reflective surface 125, a light beam L2 can radiate from the compact light source 110 at another radiation angle Al smaller than the aperture angle B and can be directly emitted through the side aperture 121 without being incident on the first reflective surface 122. Accordingly, light beams can be emitted through the side aperture 122 of the collimator 120a at an emission angle C between 0° and the aperture angle B. More specifically, the collimator 120a can collimate light beams, which have radiated from the compact light source 110 at the radiation angle A between 0° and 180°, so that the collimated light beams can be emitted at the emission angle C between 0° and the aperture angle B.

It has been assumed that since the compact light source 110 is a point light source, all of light beams can radiate from the focus F. However, the compact light source 110 is not strictly the point light source but a surface light source with a predetermined radiation area. Thus, light beams radiating from the compact light source 110 may be regarded as radiating in the vicinity of the focus F. Following an optical path, a portion of light radiating from the compact light source 110 may be reflected from the first reflective surface 122 and proceed downward without being emitted through the side aperture 121. Thus, the second reflective surfaces 124a and 124b can reflect light beams reflected from the first reflective surface 122 so that the reflected light beams can be emitted through the side aperture 121, resulting in improving light efficiency.

A light beam L3 can radiate from the compact light source 110 at the radiation angle A1 smaller than the aperture angle B, can be reflected from the third reflective surface 125, and can be incident on the first reflective surface 122. Although the light beam L3 radiates in the vicinity of the focus F of the first reflective surface 122, the light beam L3 may be seen as radiating from a point E intersecting the third reflective surface 125. Therefore, the light beam L3 can be reflected from the first reflective surface 122, and the reflected light beam may not be parallel with the principal axis 123.However, the reflected light beam can be emitted at another emission angle Cl smaller than the another radiation angle A1. Accordingly, the third reflective surface 123 can contribute to improving collimating efficiency.

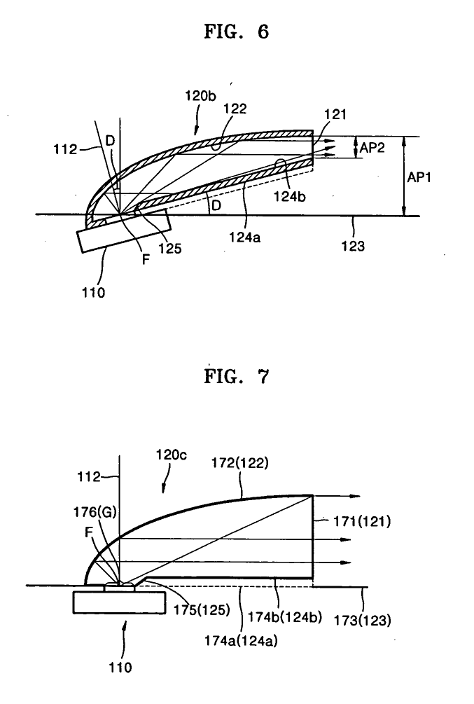

FIG. 6 is a cross-sectional view showing another example of the collimator 120 (120b). Referring to FIG. 6, the second reflective surface 124a (or 124b) may be inclined with respect to the principal axis 123 of the first reflective surface 122 at an angle D. The compact light source 110 can be installed so that its optical axis 112 is nearly perpendicular to the second reflective surface 124a (or 124b). As a result, the optical axis 112 of the compact light source 110 can be inclined with respect to the principal axis 123 of the first reflective surface 122 at the angle D. According to this structure, a size of an aperture of the collimator 120b can be reduced. A reference numeral AP2 denotes a size of the aperture of the collimator 120b, and AP1 denotes a size of an aperture of the collimator 120a of FIG. 5 in which the second reflective surface 124a (or 124b) is parallel with the principal axis 123. As can be seen in FIG. 6, the size AP2 of the aperture of the collimator 120b may be smaller than the size AP1 of the aperture of the collimator 120a. A reduction of an aperture in size can be advantageous to array a plurality of collimators.

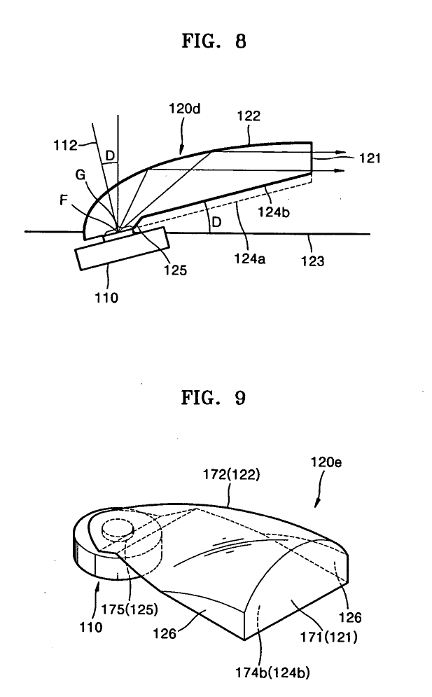

FIGS. 7 and 8 are cross-sectional views showing the collimator 120 (120c and 120d), according to different embodiments of the present general inventive concept. The embodiments of FIGS. 7 and 8are characterized by forming a collimator having a transparent body. FIG. 9 is a perspective view showing a collimator 120 (120e) corresponding to the collimator 120 (120c and 120d) of FIGS. 7 and 8.

Referring to FIGS. 3 and 7, the collimator 120c having a transparent body may include a parabolic outer surface 172, a plane lower surface 174a (or 174b), and a side aperture 171. The outer surface 172 of the transparrent body can be coated with a reflective material to reflect light beams radiating from the compact light source 110 so as to serve as the first reflective surface 122. The lower surface 174a (or 174b) of the transparrent body can be coated with a reflective material, except an area 176 through which light beams radiate, so as to serve as the second reflective surface 124a (or 124b). An incline plane 175 coated with a reflective material can be provided at an edge of the area 176 and can serve as the third reflective surface 125. The area 176 may be an optical window G. According to this structure, the collimator 120c having the transparent body can operate as the collimator 120a of FIG. 5.

The collimator 120d having a transparent body of FIG. 8 can be the same as the collimator 120b of FIG. 6 except that the collimator 120 is formed of the transparent body 120d. Hereinafter, the same elements as those of FIG. 6 are denoted by the same reference numerals and will not be explained herein. As shown in FIG. 9, adhesive surfaces 126 may be formed on the outer surface 172 of the transparrent body. The adhesive surfaces 126 may be a plane. The use of a collimator 120e having such a structure can contribute to obtaining rectangular illumination. The adhesive surfaces 126 may be applied to the collimators 120a, 120b, 120c, and 120d shown in FIGS. 5, 6, 7, and 8, respectively.

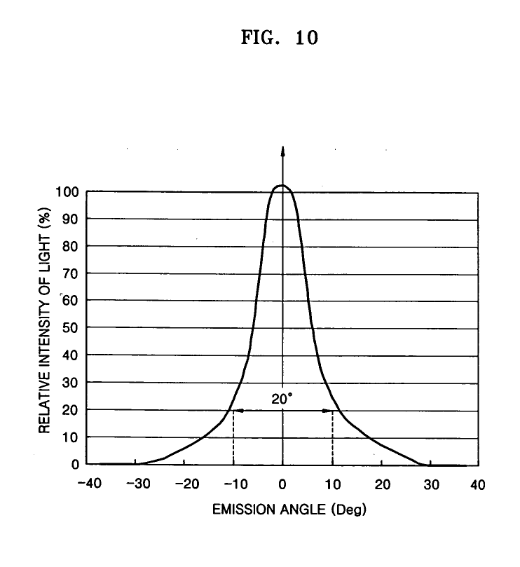

FIG. 10 is a graph showing a result of a simulation of relative intensity of light with respect to the emission angle C at which a light beam is emitted through the side aperture 121 of the collimator 120c of FIG. 7. As can be seen in FIG. 10, the light beam can be concentrated within the emission angle C of ±20°. The radiation angle A at which a light beam radiates from the compact light source 110 may be changed into an angle, such as the emission angle C, at which the light beam is efficiently incident on an object to be illuminated, so as to improve light efficiency. Also, since an illumination unit using the compact light source 110 does not require additional secondary optics, loss of light caused by the additional secondary optics may be prevented, and the illumination unit may have a simple structure.

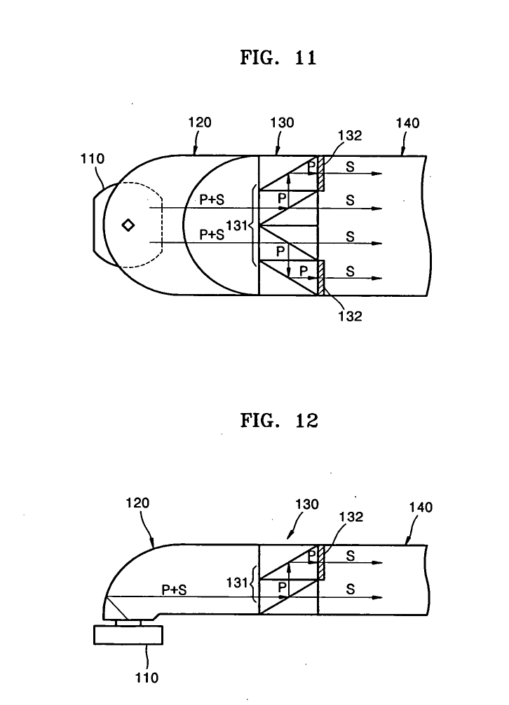

FIG. 11 is a horizontal cross-sectional view showing a portion H of the illumination unit 100 of FIG. 3. Referring to FIGS. 3 and 11, the polarization transformer 130 can transform a light beam emitted from the collimator 120 into one of P-polarized (first) and S-polarized (second) beams. The polarization transformer 130 can include a plurality of PBSs 131 and a plurality of λ/2 plates 132 which are horizontally arrayed. The PBSs 131 can transmit S-polarized beams and reflect P-polarized beams. The reflected P-polarized beams can be reflected by adjacent PBSs 131 and can pass through the λ/2 plates 132 to be transformed into S-polarized beams. Accordingly, light beams emitted from the collimator 120 can be transformed into the S-polarized beams by the polarization transformer 130 and can be incident on the integrator 140. In the present embodiment, the light beams emitted from the collimator 120 may be transformed into the P-polarized beams by the PBSs 131.

FIG. 12 is a vertical cross-sectional view showing another example of the polarization transformer 130 of FIG. 3. Referring to FIGS. 3 and 12, the polarization transformer 130 can include PBSs 131 which are vertically arrayed. The polarization transformer 130 may have various structures, for example, a structure in which the PBSs 131 and a λ/2 plate 132 are appropriately arrayed.

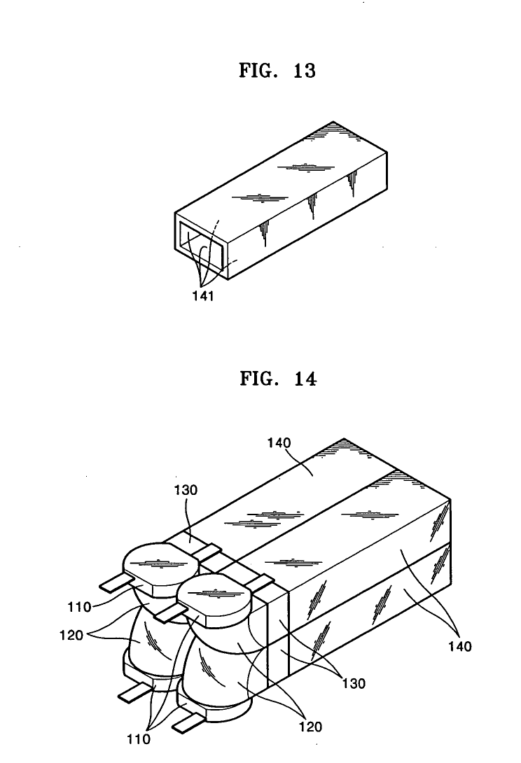

Referring to FIGS. 3 and 13, the integrator 140 may be a rectangular parallelepiped glass rod. Light beams can be incident on the integrator 140 via one end of the integrator 140 and can be repeatedly reflected from the inner surface of the integrator 140 toward the other end of the integrator 140. Since this results in mixing the light beams, light beams emitted from the integrator 140 may have uniform intensities. As shown in FIG. 13, the integrator 140 may be a parallelepiped light tunnel having inner reflective surfaces 141.

In order to secure a sufficient amount of light, as shown in FIG. 14, the illumination unit 100 can include a plurality of compact light sources 110, and a plurality of collimators 120, a plurality of polarization transformers 130, and a plurality of integrators 140 so as to be suitable for the compact light sources 110. In this case, when the collimator 120b or 120d shown in FIG. 6 or 8 is used as many compact light sources 10, polarization transformers 130, and integrators 140 as possible may be arrayed in a predetermined space. Thus, the use of the collimator 120b or 120d is advantageous to obtain brighter illumination.

An operation of the projection display according to an aspect of the present general inventive concept will now be described with reference to FIGS. 2 through 14. The LEDs 115R, 115G, and 115B sequentially operate so that the illumination unit 100 sequentially radiates the R, G, and B beams. The R, G, and B beams may have already been transformed into S-polarized beams by the polarization transformer 130. The S-polarized beams can pass through the PBS 200 and then can be incident on the reflective optical modulator 300. The reflective optical modulator 300 can selectively reflect light beams to modulate the light beams correspnding to input image information. A λ/4 plate 150 can be interposed between the reflective optical modulator 300 and the PBS 200. Since light beams are incident on the reflective optical modulator 300 and then on the PBS 200, the light beams can pass through the λ/4 plate 150 two times so as to be P-polarized beams. The P-polarized beams can be reflected from the PBS 200 toward the projection optics 400. The projection optics 400 can magnify and project the P-polarized beams.

As described above, the projection display can transform light beams so as to have specific polarization characteristics and can modulate and/or project the light beams using the specific polarization characteristics so as to improve light efficiency. Also, when an aperture of an emission portion of the illumination unit 100 is almost equal to an area of an aperture of the reflective optical modulator 300, it is possible to realize a projection display having a simple structure not requiring relay lenses.

A projection display using the above-described illumination unit to include two reflective optical modulators or three reflective optical modulators will now be explained.

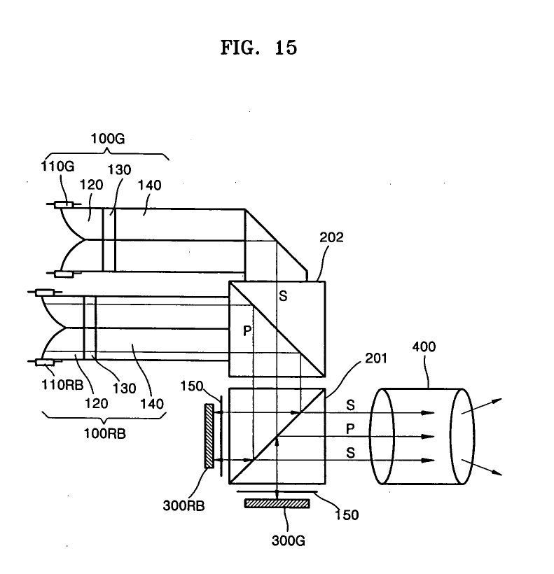

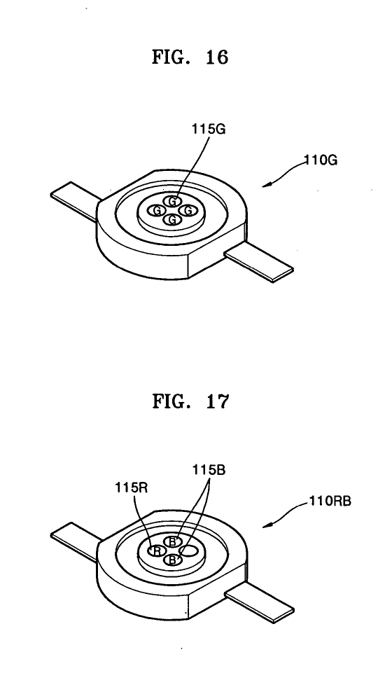

FIG. 15 is a view showing a structure of a projection display adopting two reflective optical modulators, according to another embodiment of the present general inventive concept. Referring to FIG. 15, the projection display may include a first illumination unit 100G which emits a G beam (first color beam), and a second illumination unit 100RB which emits R and B beams (second and third color beams). Each of the first and second illumination units 100G and 100RB can include a collimator 120, a polarization transformer 130, and an integrator 140. The first and second illumination units 100G and 100RB can include the same elements as those of FIGS. 3, 5 through 14 and thus will not be explained herein. The first illumination unit 100G can include a compact light source 110G having LEDs 115G as shown in FIG. 16. The second illumination unit 100RB can include a compact light source 110RB having LEDs 115R and 115B as shown in FIG. 17. In this embodiment, the polarization transformer 130 of the first illumination unit 100G can transform light beams into S-polarized beams, and the polarization transformer 130 of the second illumination unit 100RB can transform light beams into P-polarized beams. It can be understood that the opposite case is also possible. A second PBS 202 can reflect the P-polarized beams and transmit the S-polarized beams. As a result, light beams emitted from the first and second illumination units 100G and 100RB can be incident on a first PBS 201. The first PBS 201 can transmit the S-polarized beams and reflect the P-polarized beams.

The S-polarized beams emitted from the first illumination unit 100G can sequentially pass through the second and the first PBSs 202 and 201, can be incident on a reflective optical modulator 300G, and can be modulated by the reflective optical modulator 300G. A λ/4 plate 150 can be located in front of the reflective optical modulator 300G to transform the modulated light beams into P-polarized beams. Next, the P-polarized beams can be incident on the first PBS 201. The P-polarized beams can be reflected from the first PBS 201 and can be incident on projection optics 400. The second illumination unit 100RB can sequentially emit the P-polarized R and B beams. The P-polarized R and B beams can be sequentially reflected from the second and first PBSs 202 and 201, can be incident on a reflective optical modulator 300RB, and can be modulated by the reflective optical modulator 300RB. Another λ/4 plate 150 can be located in front of the reflective optical modulator 300RB to transform the modulated beams into S-polarized beams. The S-polarized beams can be incident on the first PBS 201. The S-polarized beams can passes through the first PBS 201 to be incident on the projection display 400. In this embodiment, it is possible that lengths of optical paths of R, G, and B beams up to the projection optics can be identical. According to this structure, it is possible to realize a projection display including two reflective optical modulators to sequentially modulate and project R, G, and B beams. Also, when apertures of the first and second illumination units 100G and 100RB are equal to apertures of the first and second reflective optical modulators 300G and 300RB, it is possible to realize a projection display having a simpler structure not requiring relay lenses.

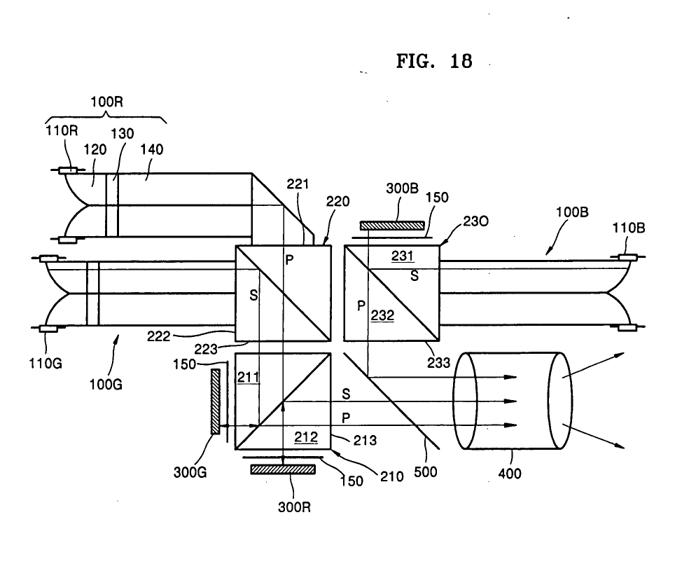

FIG. 18 is a view showing a structure of a projection display including three reflective optical modulators, according to still another embodiment of the present general inventive concept. Referring to FIG. 18, the projection display can include first, second, and third illumination units 100R, 100G, and 100B which emit R, G, and B beams, respectively. The first, second, and third illumination units 100R, 100G, and 100B can include the same elements as those of FIGS. 3 and 5 through 14, except that they include compact light sources 110R, 110G, and 110B to emit the R, G, and B beams, respectively. Thus, the first, second, and third illumination units 100R, 100G, and 100B will not be explained in detail herein. Reference numerals 210, 220, and 230 denote first, second, and third PBSs, respectively, and a reference numeral 500 denotes a color synthesizing member. Hereinafter, it will be described that the first, second, and third PBSs 210, 220, and 230 transmit P-polarized beams and reflect S-polarized beams.

The first and second illumination units 100R and 100G can emit a P-polarized R beam and an S-polarized G beam, respectively. The P-polarized R beam and the S-polarized G beam can be incident on a second PBS 220 via two orthogonal sides 221 and 222 of the second PBS 220. As described above, since the second PBS 220 transmits P-polarized beams and reflects S-polarized beams, R and G beams radiating from the first and second illumination units 100R and 100G can be emitted through a third side 223 of the second PBS 220. A first PBS 210 can be installed next to the second PBS 220. The first PBS 210 can transmit P-polarized beams and reflect S-polarized beams. A reflective optical modulator 300G, which modulates a G beam, can be installed toward a reflective side 211 of the first PBS 210. A reflective optical modulator 300R, which modulates an R beam, can be installed toward a transmission side 212 of the first PBS 210. λ/4 plates 150 can be installed in front of the reflective optical modulators 300G and 300R, respectively. The G and R beams modulated by the reflective optical modulators 300G and 300R can be emitted through an emission side 213 of the first PBS 210.

The third illumination unit 100B can emit an S-polarized B beam. A third PBS 230 can be installed toward an emission portion of the third illumination unit 100B. The third PBS 230 can transmit P-polarized beams and reflect S-polarized beams. A reflective optical modulator 300B, which modulates a B beam, can be installed toward a reflective side 231 of the third PBS 230. Another λ/4 plate 150 can be installed in front of the reflective optical modulator 300B. The B beam modulated by the reflective optical modulator 300B can be transformed into a P-polarized beam and emitted through an emission side 233 of the third PBS 230.

Referring to FIG. 18, a color synthesizing member 500 can be prepared. The color synthesizing member 500 may be a dichroic member which reflects light beams with particular wavelengths and transmits the other light beams. In this embodiment, the color synthesizing member 500 can reflect a B beam. As shown in FIG. 18, G and R beams can pass through the color synthesizing member 500 and can be incident on the projection optics 400. The B beam can be reflected from the color synthesizing member 500 and can be incident on the projection optics 400. In this embodiment, it is preferable that the lengths of optical paths of R, G, and B beams, which range from the first, second, and third illumination units 100R, 100G, and 100B to the projection optics 400, respectively, can be identical. According to this structure, it is possible to realize a projection display including three reflective optical modulators to sequentially modulate and project R, G, and B beams. Also, when apertures of the first, second, and third illumination units 100R, 100G, and 100B are almost equal to apertures of the first, second, and third reflective optical modulators 300R, 300G, and 300B, it is possible to realize a projection display having a simpler structure not requiring relay lenses.

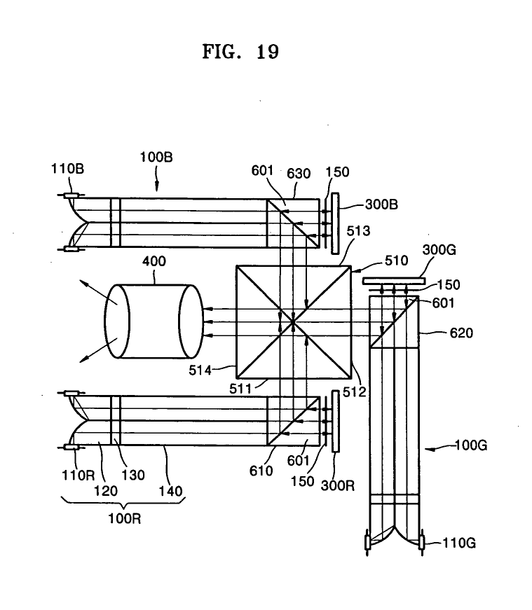

FIG. 19 is a view showing a structure of a projection display including three reflective optical modulators, according to yet another embodiment of the present general inventive concept. Referring to FIG. 19, the projection display can include first, second, and third illumination units 100R, 100G, and 100B. The first, second, and third illumination units 100R, 100G, and 100B may have the same structure as that of FIGS. 3 and 5 through 14, except that they include first, second, and third compact light sources 110R, 110G, and 100B to emit R, G, and B beams, respectively. Thus, the first, second, and third illumination units 100R, 100G, and 100B will not be explained in detail herein. Reference numerals 610, 620, and 630 denote first, second, and third PBSs, respectively, and a reference numeral 510 denotes a color synthesizing member. The color synthesizing member 510 may be an X-prism which reflects R and B beams.

The first, second, and third illumination units 100R, 100G, and 100B can emit S-polarized or P-polarized R, G and B beams, respectively. In this embodiment, the first, second, and third illumination units 100R, 100G, and 100B can emit P-polarized beams, respectively, and the first, second, and third PBSs 610, 620, and 630 can transmit P-polarized beams and reflect S-polarized beams. Reflective optical modulators 300R, 300G, and 300B can be installed toward emission sides of the first, second, and third PBSs 610, 620, and 630, respectively. λ/4 plates 150 can be installed in front of the reflective optical modulators 300R, 300G, and 300B, respectively. The first, second, and third PBSs 610, 620, and 630 can be installed so that their reflective portions face first, second, and third sides 511, 512, and 513 of the color synthesizing member 510, respectively. Projection optics 400 can be installed toward a fourth side 514 of the color synthesizing member 510.

According to this structure, P-polarized R, G, and B beams radiating from the first, second, and third illumination units 100R, 100G, and 100B can transmit to the reflective modulators 300R, 300G, and 300B via the first, second, and third PBSs 610, 620, and 630. The first, second, and third PBSs 610, 620, and 630 can modulate the P-polarized R, G, and B beams. The modulated R, G, and B beams can be incident on the first, second, and third PBSs 610, 620, and 630, respectively. As a result, the R, G, and B beams can pass through the λ/4 plates 150 two times to be S-polarized. Thus, the modulated R, G, and B beams can be reflected from the first, second, and third PBSs 610, 620, and 630 and can be incident on the color synthesizing member 510 via the first, second, and third sides 511, 512, and 513. Here, the R and B beams can be reflected from the color synthesizing member 510, and the G beam can pass through the color synthesizing member 510 and can be incident on the projection display 400. In this embodiment, it is preferable that the lengths of optical paths of the R, G, and B beams, which range from the first, second, and third illumination units 100R, 100G, and 100B to the projection optics 400, respectively, are identical. According to this structure, it is possible to realize a projection display including three reflective optical modulators to sequentially modulate and project R, G, and B beams. Also, when apertures of the first, second, and third illumination units 100R, 100G, and 100B are almost equal to apertures of the first, second, and third reflective optical modulators 300R, 300G, and 300B, it is possible to realize a projection display having a simpler structure not requiring relay lenses.

As described above, a projection display according to the present general inventive concept can achieve the following effects.

First, the projection display can include a collimator which collimates a light beam using reflective surfaces. Thus, the light beam can be further effectively collimated compared to a condensing optical system using lenses.

Second, since the projection display does not require additional secondary optics, loss of light caused by the additional secondary optics can be prevented, and a simple and compact illumination unit can be embodied.

Third, the projection display can adopt an LED as a compact light source to provide a long life span.

Fourth, the projection display can include a polarization transformer to improve light efficiency.

Fifth, since the projection display can use simple reflective optical modulators, it is possible to realize a projection display adopting the simple reflective optical modulators.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

1. A projection display comprising:
an illumination unit which sequentially emits first, second, and third color beams;
a reflective optical modulator which sequentially modulates the first, second, and third color beams corresponding to image data;
a λ/4 plate which is installed in front of the reflective optical modulator;
projection optics which magnifies and projects the modulated first, second, and third color beams; and
a polarization beam splitter which allows the first, second, and third color beams to be incident on the reflective optical modulator and the modulated first, second, and third beams to be incident on the projection optics,
wherein the illumination unit comprises:
a collimator which comprises a first reflective surface that is parabolic and reflects a light beam radiating from a lower portion thereof toward a side portion thereof, and a second reflective surface that comprises an optical window through which the light beam radiates and which faces the first reflective surface,
at least one compact light source which is located at a vicinity of a focus of the first reflective surface and sequentially radiates the first, second, and third color beams toward the first reflective surface through the optical window,
a polarization transformer which transforms a light beam emitted from the collimator into one of a first polarized beam and a second polarized beam, and
at least one integrator which transforms a light beam emitted from the polarization transformer into another light beam having uniform intensities.

2. The projection display of claim 1, wherein the at least one compact light source has an optical axis perpendicular to a principal axis of the first reflective surface.

3. The projection display of claim 1, wherein the collimator further comprises a third reflective surface which inclines at an edge of the optical window and reflects a light beam radiating from the at least one compact light source at an angle smaller than an aperture angle toward the first reflective surface, and the aperture angle is an angle formed between the second reflective surface and a line connected between the at least one compact light source and an end of the side aperture opposite to the first reflective surface.

4. The projection display of claim 1, wherein the second reflective surface inclines with respect to a principal axis of the first reflective surface, and the at least one compact light source is installed so that its optical axis inclines with respect to the principal axis at the same angle at which the second reflective surface inclines with respect to the principal axis.

5. The projection display of claim 1, wherein the at least one integrator comprises a parallelepiped glass rod.

6. The projection display of claim 1, wherein the polarization transformer comprises:
a polarization beam splitter which transmits one of the first and second polarized beams and reflects the other one of the first and second polarized beams; and
a λ/2 plate which transforms one of the transmitted and reflected beams into the other one of the first and second polarized beams.

7. The projection display of claim 1, wherein the illumination unit comprises an aperture formed on the side portion to have the same size as the size of an aperture of the reflective optical modulator.

8. A projection display comprising:
a first illumination unit which comprises at least one first compact light source that emits a first color beam;
a second illumination unit which comprises at least one second compact light source that emits second and third color beams;
first and second reflective optical modulators which modulate the first color beam and the second and third color beams, respectively, corresponding to image data;
λ/4 plates installed in front of the first and second reflective optical modulators;
projection optics which magnifies and projects the modulated beams;
a first polarization beam splitter which allows the first beam and the second and third color beams to be incident on the first and second reflective optical modulators, respectively, and the modulated beams to be incident on the projection optics; and
a second polarization beam splitter which allows the first beam emitted from the first illumination unit and the second and third color beams emitted from the second illumination unit to be incident on the first polarization beam splitter,
wherein each of the first and second illumination units comprises:
at least one collimator which comprises a first reflective surface that is parabolic and reflects a light beam radiating from one of the first and second compact light sources located at a vicinity of a focus of the first reflective surface toward a side aperture, and a second reflective surface that comprises an optical window through which the light beam radiates and that faces the first reflective surface,
at least one integrator which transforms light beams into beams to have uniform intensities, and
a polarization transformer which is installed between the collimator and the integrator and transforms a light beam into one of first and second polarized beams.

9. The projection display of claim 8, wherein the collimator further comprises a third reflective surface which inclines at an edge of the optical window and reflects a light beam radiating at an angle smaller than an aperture angle toward the first reflective surface, and the aperture angle is an angle formed between the second reflective surface and a line connected between the first or second compact light source and an end of the corresponding side aperture opposite to the corresponding first reflective surface.

10. The projection display of claim 8, wherein the second reflective surface inclines with respect to a principal axis of the first reflective surface, and the compact light source is installed so that its optical axis inclines with respect to the principal axis at the same angle at which the second reflective surface inclines with respect to the principal axis.

11. The projection display of claim 8, wherein the side aperture of the first and second illumination units have the same sizes as sizes of apertures of the first and second reflective optical modulators.

12. A projection display comprising:
first, second, and third illumination units which radiate first, second, and third color beams, respectively;
first, second, and third reflective optical modulators which modulate the first, second, and third color beams so as to correspond to image data;
λ/4 plates installed in front of the first, second, and third reflective optical modulators, respectively;
a color synthesizing member which transmits the first and second color beams and reflects the third color beam to synthesize the first, second, and third color beams;
projection optics which magnifies and projects the synthesized beam;
a first polarization beam splitter which allows the first and second color beams to be incident on the first and second reflective optical modulators, respectively, and the modulated beams to be incident on the color synthesizing member;
a second polarization beam splitter which allows the first and second color beams to be incident on the first polarization beam splitter; and
a third polarization beam splitter which allows the third color beam to be incident on the third reflective optical modulator and the modulated beams to be incident on the color synthesizing member,
wherein each of the first, second, and third illumination units comprises:
a collimator which comprises a first reflective surface that is parabolic and reflects a light beam radiating from a lower portion thereof toward a side portion thereof, and a second reflective surface that comprises an optical window through which the light beam radiates, and which faces the first reflective surface,
at least one compact light source located at a vicinity of a focus of the first reflective surface to radiate a light beam toward the first reflective surface through the optical window,
at least one integrator which transforms light beams to have uniform intensities, and
a polarization transformer which is installed between the collimator and the integrator to transform a light beam into one of first and second polarized beams.

13. The projection display of claim 12, wherein the collimator further comprises a third reflective surface which inclines at an edge of the optical window and reflects a light beam radiating at an angle smaller than an aperture angle toward the first reflective surface, and the aperture angle is an angle formed between the second reflective surface and a line connected between the first or second compact light source and an end of the corresponding side aperture opposite to the corresponding first reflective surface.

14. The projection display of claim 12, wherein the second reflective surface inclines with respect to a principal axis of the first reflective surface, and the at least one compact light source is installed so that its optical axis inclines with respect to the principal axis at the same angle at which the second reflective surface inclines with respect to the principal axis.

15. The projection display of claim 12, wherein the first, second, and third illumination units comprise apertures formed on the side portion to have the same sizes as sizes of the first, second, and third reflective optical modulators, respectively.

16. A projection display comprising:
first, second, and third illumination units which radiate first, second, and third color beams, respectively;
first, second, and third reflective optical modulators which modulate the first, second, and third color beams so as to correspond to image data;
λ/4 plates installed in front of the first, second, and third reflective optical modulators, respectively;
a color synthesizing member which synthesizes the modulated first, second, and third color beams;
first, second, and third polarization beam splitters which allow the first, second, and third color beams to be incident on the first, second, and third reflective optical modulators, respectively, and the modulated first, second, and third color beams to be incident on the color synthesizing member; and
projection optics which magnifies and projects the synthesized beam,
wherein each of the first, second, and third illumination units comprises:
a collimator which comprises a first reflective surface that is parabolic and reflects a light beam radiating from a lower portion thereof toward a side portion thereof, and a second reflective surface that comprises an optical window through which the light beam radiates and that faces the first reflective surface,
at least one compact light source which is located at a vicinity of a focus of the first reflective surface and radiates a light beam toward the first reflective surface through the optical window,
at least one integrator which transforms light beams to have uniform intensities, and
a polarization transformer installed between the collimator and the integrator to transform a light beam into one of first and second polarized beams.

17. The projection display of claim 16, wherein the collimator further comprises a third reflective surface which inclines at an edge of the optical window and reflects a light beam radiating at an angle smaller than an aperture angle toward the first reflective surface, and the aperture angle is an angle formed between the second reflective surface and a line connected between the first or second compact light source and an end of the corresponding side aperture opposite to the corresponding first reflective surface.

18. The projection display of claim 16, wherein the second reflective surface inclines with respect to a principal axis of the first reflective surface, and the at least one compact light source is installed so that its optical axis inclines with respect to the principal axis at the same angle at which the second reflective surface inclines with respect to the principal axis.

19. The projection display of claim 16, wherein the first, second, and third illumination units comprise apertures formed on the side portion to have the same sizes as sizes of the first, second, and third reflective optical modulators.
